(19) United States
(12) Patent Application Publication
(10) Pub. No.: US 2024/0305010 A1
(43) Pub. Date: Sep. 12, 2024

(54) INTEGRATION OF WIRELESS FRESNEL LENS INTO ALTERNATIVELY FUNCTIONAL MATERIAL TO IMPROVE WIRELESS COMMUNICATIONS

(71) Applicant: ORC TECH, LLC, Albuquerque, NM (US)

(72) Inventors: JOSHUA BENAVIDEZ, ALBUQUERQUE, NM (US); JOHN CHAVEZ, ALBUQUERQUE, NM (US)

(73) Assignee: ORC TECH, LLC, Albuquerque, NM (US)

(21) Appl. No.: 18/531,207

(22) Filed: Dec. 6, 2023

Related U.S. Application Data
(60) Provisional application No. 63/430,438, filed on Dec. 6, 2022.

(51) Int. Cl. H01Q 19/06; H01Q 1/22

(52) U.S. Cl. CPC H01Q 19/065; H01Q 1/22

(57) ABSTRACT

Wireless communications can be improved through a Fresnel lens. The Fresnel lens can be integrated into or onto nonconductive material adapted to serve an alternative useful function (e.g., tent, decorative screen, curtain, umbrella, window tinting film) having at least one surface and that is comprised of the nonconductive material. The Fresnel lens supported by the nonconductive material is configured to improve wireless communications by communication equipment located near the Fresnel lens by increasing signal to noise ratio (SNR) ratio in wireless communication links.

### INVENTION PRIORITY

The present application claims priority as a continuation of U.S. Provisional Application No. 63/430,438, filed Dec. 6, 2022 and entitled “Integration of wireless fresnel lens into alternatively functional material to improve wireless communications”, which is herein incorporated by references in its entirety.

### TECHNICAL FIELD

The embodiments described herein are generally related to systems and methods for enhancing wireless communications by improving wireless gain. More particularly, the embodiments are related to the integration of a wireless Fresnel lens into/onto material serving an alternate purpose (e.g., tent walls, umbrella coverings, privacy screens, curtains, window tint) as a signal enhancement to improve wireless communications by communications equipment including wireless portable electronic devices.

### BACKGROUND

In U.S. Pat. No. 8,384,614 B1 (“614 patent”), issued Feb. 26, 2013, National Aeronautics and Space Administration (NASA) inventors disclosed a means to address the need for improved signal communications systems and for an improved Fresnel lens to increase the signal to noise ratio (SNR) ratio in wireless communication links, thereby improving the range and performance of wireless devices. The '614 patent details how to solve address these needs using an improved Fresnel lens, which basically utilizes concepts of a Fresnel lens and incorporate them for use between wireless communications transmitters and receivers as an antenna enhancement to pass wanted signals while suppressing or eliminating unwanted signals. The '614 patent in incorporated herein by reference in its entirety for its teaching.

NASA inventors found that portable, wireless communication devices often require an increased SNR. The need can arise from increased range, higher data rates, and compromised channels—e.g., RF interference and rain fade. Increased SNR can also be required in urban environments because of urban blockage, either on foot or in an automobile, where buildings and materials cause exacerbated fading conditions. Natural disasters can further diminish the operational effectiveness of traditional methods of communication thereby creating a need for increased SNR. For example, hurricanes and earthquakes can damage transmission links, such as mobile phone towers, requiring an increased range of communication for remaining undamaged communication links to maintain geographic coverage. Highly critical government communication applications can also require increased SNR. Individuals, such as boaters, hunters, campers, or stranded motorists, would benefit from an increase in the SNR of their wireless portable communication devices, such as radios, pagers, and mobile phones.

Despite the brilliant teachings of the '614 patent, a need still exists for improved means to effectively support the deployment of Fresnel lenses as an antenna transmission/receiving enhancement and improve the effectiveness of communications equipment, and thereby also improving the range and performance of wireless portable electronic devices.

### SUMMARY OF THE EMBODIMENTS

What is generally described is the integration of a Fresnel lens into material serving an alternative purpose to operate together as a passive enhancement for antennas associated with electronic communications devices and enhancing the gain of wireless signals by antennas, such as the Fresnel lens taught by the '614 patent, is described.

In a first embodiment, a Fresnel lens can be integrated into the material of at least one surface of a tent to enhance mobile device communications operating therein. Material comprising the walls or ceilings of a tent can act as a support member for a Fresnel lens having a center defined by electrically non-conductive material surrounded by electrically conductive material.

In accordance with another embodiment, a Fresnal lens can be integrated into the material of an umbrella to enhance mobile device communications operating therein. Material comprising the umbrella can act as a support member for a Fresnel lens having a center defined by electrically non-conductive material surrounded by electrically conductive material.

In accordance with another embodiment, a Fresnal lens can be integrated into the material of a screen to enhance mobile device communications operating therein. Material comprising the screen can act as a support member for a Fresnel lens having a center defined by electrically non-conductive material surrounded by electrically conductive material. The screen can also be a curtain covering a window or entry way.

In accordance with another embodiment, a Fresnal lens can be integrated into a plastic layer of material that can adhere to the surface of a window to enhance mobile device communications operating near the Fresnel lens. The plastic layer material can be provided in the form of window tint. The plastic layer material can also be provided in the form of clear sheet of vinyl that is flexible and can adhere to just a portion of a window. Material comprising the plastic layer can act as a support member for a Fresnel lens having a center defined by electrically non-conductive material surrounded by electrically conductive material.

In accordance with another embodiment, the material supporting the Fresnel lens can be provided in the form of at least one of a tent, umbrella, screen, window tint, and can be further provided in the form of at least one of a circle, square, rectangle.

In accordance with another embodiment, any of the tent, umbrella and screen can be collapsed for storage together with the Fresnel lens.

In accordance with another embodiment, any of the tent, umbrella, screen, window tint can be made from non-conductive fabric.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1, labeled as prior art, depicts a side view of an illustrative Fresnel lens.

FIG. 2, labeled as prior art, depicts a partial cross-sectional view of the Fresnel lens depicted in FIG. 1 along line 2-2.

FIG. 3, labeled as prior art, depicts a schematic diagram of an illustrative communication link utilizing the Fresnel lens depicted in FIG. 1.

FIG. 4, labeled as prior art, depicts a side view of the Fresnel lens depicted in FIG. 1 in a partially folded configuration.

FIG. 5, labeled as prior art, depicts a side view of the Fresnel lens depicted in FIG. 1 in a partially collapsed configuration.

FIG. 6, labeled as prior art, depicts a side view of the Fresnel lens depicted in FIG. 1 in a compact configuration.

FIG. 7, labeled as prior art, depicts a schematic diagram of an illustrative wireless device utilizing the Fresnel lens depicted in FIG. 1 to enhance the gain of one or more signals sent to and from the wireless device, according to one or more embodiments described.

FIG. 8 a front-right perspective view of support structure in the form of a tent for a Fresnel lens, according to an embodiment.

FIGS. 9A-B depict side and top perspectives of support structure in the form of an umbrella for a Fresnel lens, according to an embodiment.

FIG. 10 depicts a front perspective of a Fresnal lens support structure in the form of a decorative screen for a Fresnel lens, according to an embodiment.

FIG. 11 depicts top a front perspective of a Fresnal lens support structure in the form of a plastic layer (e.g., window tint) that can adhere to the surface of a window, according an embodiment.

### DETAILED DESCRIPTION

A detailed description will now be provided. Each of the appended claims defines a distinct embodiment of the invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the embodiments will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

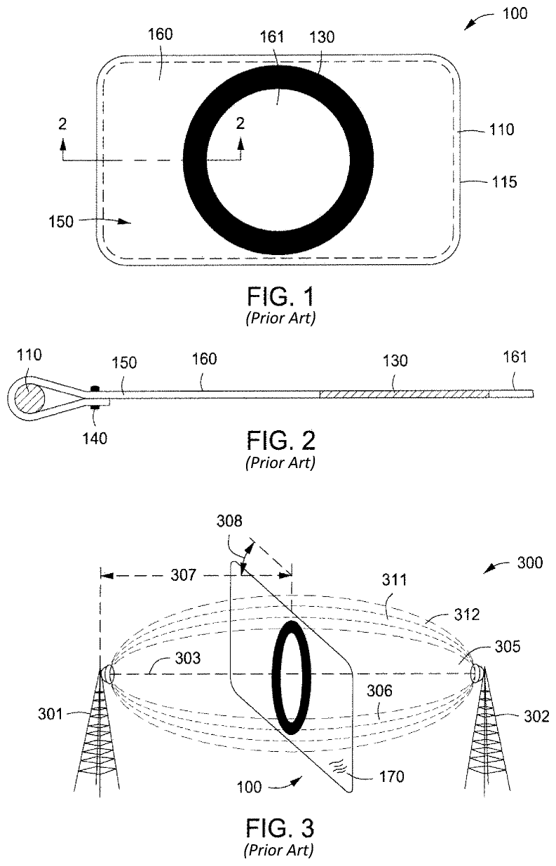

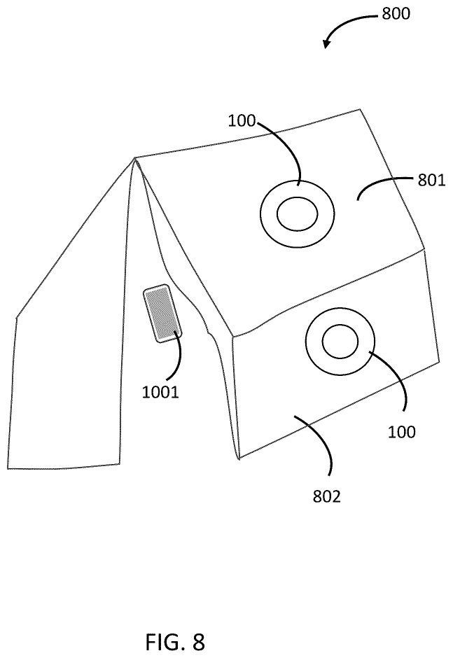

Reference to “Fresnel lens” throughout this detailed description should be interpreted to refer to a passive enhancement for antennas associated with electronic communications devices and enhancing the gain of wireless signals received by the antennas, such as the Fresnel lens taught by the '614 patent. FIGS. 1-7 provide background on the Fresnel lens and its operation. FIGS. 8-11 describe improvements for effective deployment and use of the Fresnel lens, in accordance with one or more of the embodiments of the invention.

Referring to FIG. 1, labeled as prior art, depicted is a front view of an illustrative Fresnel lens or Fresnel zone plate 100. As used herein, the term “lens” can refer to any three-dimensional structure, through which electromagnetic waves can pass and that uses either refraction or diffraction to control the exiting aperture distribution as a function of its position and shape. As used herein, the terms “Fresnel lens” or “Fresnel zone plate” can refer to a type of lens that produces focusing and imaging of electromagnetic waves using diffraction, rather than refraction. It is noted that a lens and hence, a Fresnel lens, are not antennas. An antenna is a transducer that transmits or receives electromagnetic waves. Conversely, a Fresnel lens does not transmit or receive electromagnetic waves. A Fresnel lens operates more like a filter when it comes to wireless electromagnetic waves. As stated above and as will be discussed in more detail supra, electromagnetic waves are passed through a Fresnel lens wherein said electromagnetic waves may be focused into Fresnel zone regions.

The Fresnel lens 100 can include one or more screens 150. As used herein, the term “screen” refers to a monolithic body, sheet, or membrane having a thickness that is less than its length and width. The screen 150 can have any shape or combination of geometrical shapes. The shape of the screen 150 can be symmetric or asymmetric. Illustrative shapes can include, but are not limited to, square, rectangular, triangular, circular, elliptical, pentagonal, hexagonal, other polygonal shapes, non-uniform shapes, or a combination thereof. The screen 150 shown in FIG. 1 is rectangular, which has a length longer than its width, a width longer than its length. If provided in the form of a square, the width and length can be equal. The screen 150 can be formed of a deformable and/or flexible material or fabric. As used herein, the term “deformable” refers to the ability of the material or fabric to twist, bend, flex, turn, and/or change shape. The screen 150 can have a total thickness ranging from a low of about 0.01 mm, about 0.5 mm, about 1.5 mm, or about 2.5 mm to a high of about 4 mm, about 7.5 mm, or about 10 mm. The screen 150 can also have a total thickness of from about 0.25 mm to about 8 mm, from about 1 mm to about 6 mm, or from about 2 mm to about 5 mm.

The screen 150 can have one or more electrically conductive regions 130 and one or more non-conductive regions (two are shown 160, 161). The one or more electrically conductive regions 130 can be disposed adjacent to at least one of the non-conductive regions 160, 161. The one or more electrically conductive regions 130 can be a ring shaped conductive region and can be disposed between an inner non-conductive region 161 and an outer non-conductive region 160. As used herein, the term “conductive” is used interchangeably with the term “electrically conductive.” The electrically conductive region 130 can be woven into or otherwise disposed within the screen 150. In another example, the electrically conductive region 130 can be formed by disposing an electrically conductive material or layer on a surface of the screen 150, attaching the electrically conductive material or layer to the surface of the screen 150, embedding the electrically conductive material at least partially within the screen 150, or any combination thereof.

The outer non-conductive region 160 and the inner non-conductive region 161 can be formed by disposing a non-conductive material or layer on the surface of the screen 150, attaching a non-conductive or insulating material to the surface of the screen 150, embedding the non-conductive material at least partially within the screen 150, or any combination thereof, where the screen 150 is non-conductive. Alternatively, the outer non-conductive region 160 and the inner non-conductive region 161 can be or can include the portion of the screen 150 that does not include the electrically conductive region 130.

The electrically conductive material used in the electrically conductive region 130 can be made of or include an electrically conductive fabric, which can include any kind of electronic textile or “e-textile”. E-textiles can include any textile that can be applied to the physical manipulation of electrical or electromagnetic signals or radiation; most often, this is associated with devices that incorporate one or more electronic devices. Electronic textiles can provide several advantages for portable Fresnel lenses and applications thereof. Electronic textiles are often lightweight with low mass. In addition, they can be both foldable and flexible. E-textiles may be constructed from materials that are resistant to the elements and/or extreme environments. For example, NOMEX®, having excellent thermal, chemical, and radiation resistance, can be used as a base nonconductive e-textile material element. As such, when electrically conductive region 130 includes e-textiles, the Fresnel lens 100 can be lightweight, low mass, foldable, flexible, and/or resistant to the elements. Metals that can be used in the construction of electronic textiles can include, but are not limited to, copper, nickel, gold, silver, steal, zinc, tin, tungsten, iron, iridium, aluminum, alloys thereof, or other conductive elements. Metalized fiber strands can include polymers coated with metal. Other conducting fabric strands can include electrically conducting polymers or plastics. Electronic textiles can include multiple metalized fibers wrapped together to form electrically conductive strands. Electronic textiles can include nano-tubes or other nano-particles that have advanced electronic function. In another embodiment, the electrically conductive region 130 can be made using metal meshes, such as a copper wire or gold wire mesh.

Just as there can be many different means to creating conductive fabrics for use with c-textiles, numerous non-conductive materials can be used in conjunction with the aforementioned conductive materials. Suitable non-conductive materials can include, but is not limited to, nylon, NOMEX®, KEVLAR®, aromatic polyamide polymers, polyester, cotton, Rip-stop nylon, canvas, other common textiles or materials having bulk electrical properties fitting the description a good non-conductor, or combinations thereof. The non-conductive material can be in the form of a web having air or a vacuum dispersed through non-conductive strands.

The conductivity of the electrically conductive region 130 and conductivity of the non-conductive region 160 can be reversed. For example, the electrically conductive region 130 can be a non-conductive region made of non-conductive fabric, and the non-conductive regions 160, 161 can be conductive regions made of all or mostly conductive fabric. The non-conductive regions can also be the same material with the conductive region affixed near the center of the material defining the non-conductive regions after its placement.

The Fresnel lens 100 can further include a support member 110 that can be at least partially disposed about the screen 150. The support member 110 is preferably located about or along a perimeter 115 of the screen 150 to provide support or rigidity to the screen 150. The support member 110 can be a single component or body or can include multiple pieces or sections that are joined together. In one embodiment, the support member 110 is a single component that makes a complete loop, i.e., the support member 110 is connected at a first and second end thereof. Because the screen 150 is flexible and deformable, the shape of the support member 110 disposed about the perimeter 115 can define the shape of the Fresnel lens 100. In addition, the support member 110 can stretch the screen 150 and can keep it substantially flat or planar.

The screen 150 and therefore, the Fresnel lens 100 can be configured to be deployable. The term “deployable” as used herein refers to the ability of the screen and therefore, the Fresnel lens, to spread out or extend. The screen 150 and therefore, the Fresnel lens 100 can have an open, extended, spread out, or un-collapsed configuration, where the open configuration of the screen 150 and therefore, the Fresnel lens 100 can have a plurality of shapes, including, but not limited to, generally circular, generally elliptical, generally square, generally triangular, or other shape as required to suit an application or function in which it is used. For example, the Fresnel lens 100 can be non-planar having spherical or parabolic shape. As depicted in FIG. 1, in the open configuration the Fresnel lens 100 can have a generally rectangular shape. For example, the Fresnel lens 100 can have two sets of substantially parallel sides with four interconnecting curved corners. The Fresnel lens 100 can also be configured to be portable, i.e., easily carried or packed away. In one embodiment, the Fresnel lens 100 can be a low weight and/or low mass device. For example, the Fresnel lens 100 can have a mass ranging from a low of about 0.05 kg to a high of about 5 kg.

Referring to FIG. 2, labeled as prior art, depicted is a partial cross-sectional view of the Fresnel lens 100 depicted in FIG. 1 along line 2-2. One or more layers of the screen 150 can be secured to the support member 110. The screen 150 can be secured to the support member 110 by wrapping the screen 150 around the support and fastening a portion of the screen 150 to another portion of the screen 150 or to the support member 110. The screen 150 can be fastened to itself or the support member 110 using any suitable fastener or combination of fasteners 140. Illustrative fasteners can include, but are not limited to, adhesives, thread, brackets, staples, epoxy, rivets, clamps, or any combination thereof. In one embodiment, the support member 110 can be sewn into at least a portion of the screen 150 using a thread as the fastener 140. The support member 110 can be formed of a spring-like material. A spring-like material may be described as any elastic body or device that recovers its original shape when released after being distorted. The spring-like material of the support member 110 can be deformable and can be conductive, non-conductive, or partially conductive and partially non-conductive. For example, the spring-like material can include, but is not limited to, plastic, metal, rubber, fiber, fiberglass, carbon, carbon-glass composites, or a combination thereof. Other materials that can be used in the support member include shape memory allows, shape memory polymers, or a combination thereof. The support member 110 can include, but is not limited to, a circular cross-section, an elliptical cross-section, a square cross-section, a rectangular cross-section, a triangular cross section, polygonal cross-section, and any other cross-sectional shape or combination thereof. With the ability to collapse into a smaller form, the Fresnel lens 100 can also be easily carried or packed away in, for example, a backpack.

FIG. 3, labeled as prior art, depicts a schematic diagram of an illustrative communication link 300 utilizing the Fresnel lens 100 depicted in FIG. 1, according to one or more embodiments. The communication link 300 can include both a transmitting or transmission source 301 and a receiver 302, with a transmission path 303 formed therebetween. In operation, the Fresnel lens 100 through its one or more screens can cancel or block at least a portion of an out-of-phase radiated field produced by the transmission source 301, at any instant of time, passing through a planar cut that is orthogonal to the transmission path 303. The cancellation of the out-of-phase radiation can be accomplished by insertion of the electrically conductive region 130 of the Fresnel lens' 100 one or more screens, such that it blocks or covers one or more Fresnel zone regions (four Fresnel zone regions are shown 305, 306, 311, 312) at a predetermined distance 307 from the transmission source 301 in the transmission path 303. The shape and location of four Fresnel zone regions are depicted diagrammatically as 305, 306, 311, and 312. Fresnel zones are inherent to all wireless communication links. Any transmission from a source or transmitter, such as the transmission source 301, can produce both in-phase and out-of-phase radiation defined by Fresnel zones. Fresnel zones can be concentric ellipsoids of revolution that define volumes of in-phase and out-of-phase radiation from the transmission source 301.

The in-phase radiation can be defined by a first Fresnel zone region 305 and a third Fresnel zone region 311, and the out-of-phase radiation can be defined by a second Fresnel zone region 306 and a fourth Fresnel zone region 312. As shown, the first Fresnel zone region 305 can bound in-phase radiation and the second Fresnel zone region 306 can bound out-of-phase radiation. Placing the Fresnel lens 100 at the predetermined distance 307 and at a predetermined angle 308 relative to a transmission or receiver source can result in gain enhancement, focusing of radiated energy from the transmission source 301, signal improvement at the receiver 302 relative to that of a communication link without the Fresnel lens 100, or any combination. This result can be accomplished, at least in part, by cancelling the out-of-phase radiation in Fresnel zone region 306. The predetermined angle 308 may be any angle whereby the Fresnel lens 100 is orthogonal to the transmission path. For example, the electrically conductive region 130 can diffract, reflect, interfere with, block, or cancel out the out-of-phase radiation in Fresnel zone 306 to enhance transmission gain and improve SNR in the communication link 300. As such, the Fresnel lens 100 does not require a direct wired connection to the transmission source 301 nor a source of power, i.e., a plug or battery, to perform gain enhancement in the communication link 300.

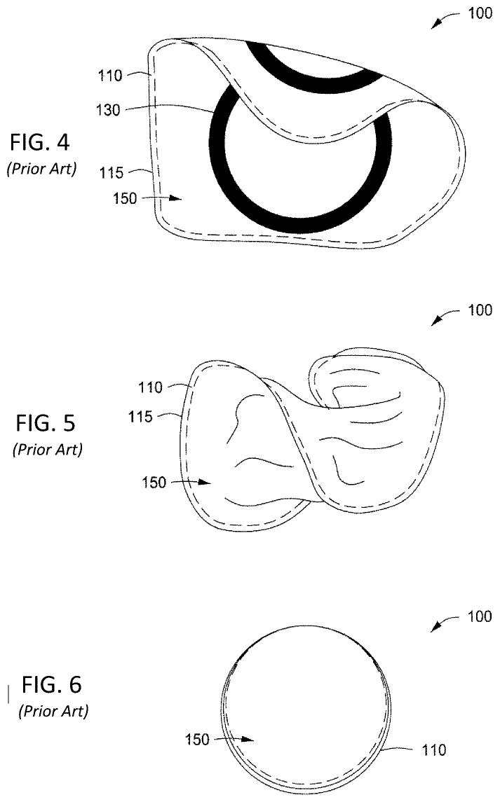

FIGS. 4-6 show at least one embodiment for collapsing the Fresnel lens 100 into a reduced volume or a compact configuration. One method of collapsing the Fresnel lens 100 can comprise grasping the support member 110 with the screen 150 attached thereto at its extreme or opposing ends or points, twisting the ends in opposite screw senses while simultaneously bringing the ends toward each other. Opposite screw senses as used herein refers to rotation in opposite directions.

FIG. 4 depicts a side view of the Fresnel lens 100 depicted in FIG. 1 in a partially folded configuration, according to one or more embodiments. As the ends are twisted together, the Fresnel lens 100 can be partially folded on itself, as depicted.

FIG. 5 depicts a side view of the Fresnel lens 100 depicted in FIG. 1 in a partially collapsed configuration, according to one or more embodiments. As the ends are twisted further, the Fresnel lens 100 can begin to collapse into a spiral looking shape as depicted in FIG. 5.

FIG. 6 depicts a side view of the Fresnel lens 100 depicted in FIG. 1 in a compact or closed configuration, according to one or more embodiments. Once the ends are completely twisted and folded, the folds of the Fresnel lens 100 can be formed into a number of interleaved sections consisting of generally circular loops. The generally circular loops can be pressed down to form the compact configuration shown in FIG. 6. The Fresnel lens 100 can easily and conveniently collapse into the compact configuration for storage when not in use, as is illustrated in FIG. 6. The general structure and method of collapsing as illustrated in FIGS. 4-6 can be utilized for the Fresnel lenses 400, 500, and/or 600, as well. An alternative method of collapsing the Fresnel lenses can involve one or more folds along predetermined creases.

The Fresnel lens 100 can have a plurality of shapes in the compact configuration, including, but not limited to, generally polygonal, generally elliptical, generally square, generally triangular, or other shape as required. As depicted in FIG. 6, the Fresnel lens 100 can have a generally circular shape in the compact configuration. The shape of the Fresnel lens 100 in the compact configuration can depend, at least in part, on the shape required for the un-collapsed configuration and the manner in which the Fresnel lens 100 is folded.

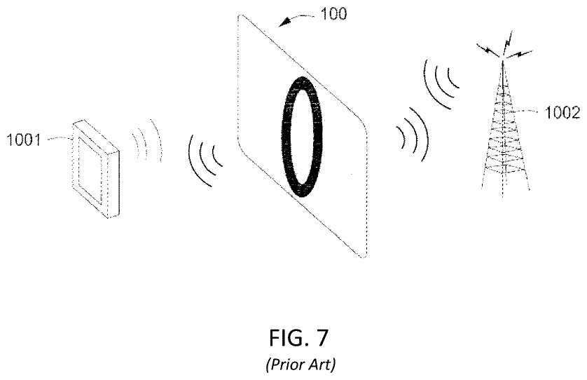

FIG. 7 depicts a schematic diagram of an illustrative wireless device 1001 placed proximate to a Fresnel lens 100 or in a predetermined Fresnel zone region to enhance the gain of a signal transmitted from the wireless device 1001 (e.g., a cellular phone, smartphone, tablet, laptop, IoT device) as well as to enhance the gain of a signal received by the wireless device 1001 which has been transmitted by one or more transceivers 1002 (e.g., a cell phone tower, a wireless router, etc.), according to one or more embodiments. As described infra, placing the Fresnel lens 100 at a predetermined distance and at a predetermined angle relative to a transmission or receiver source can result in gain enhancement, focusing of radiated energy from the transmission source, signal improvement at the receiver relative to that of a communication link without the Fresnel lens, or any combination. FIG. 7 also illustrates the distinction that the Fresnel lens 100 is not an antenna. Antennas are operably integrated on the one or more wireless devices 1001 and the one or more transceivers 1002. FIG. 7 also illustrates the fact that no direct wire connection(s) are required between the Fresnel lens 100 and the one or more wireless devices 1001. The Fresnel lens 100 can be used to enhance the signal gain of one or more wireless devices 1001 transmitted to one or more transceivers 1002. Further, the Fresnel lens 100 can be used to enhance the signal gain of one or more transceivers 1002 transmitted to one or more wireless devices 1001. The wireless devices 1001 can include, but are not limited to, mobile phones, smartphones, tablet devices, personal digital assistants (PDA), cameras, global positioning systems (GPS), wireless adapters or PCI cards for computing devices (e.g., Bluetooth® or 802.11 devices), radios, transmitters, Internet of Things (IoT) devices, or any combination thereof.

As mentioned in the description with respect to FIG. 3, placing the Fresnel lens 100 at the predetermined distance 307 and at a predetermined angle 308 relative to a transmission or receiver source can result in gain enhancement, focusing of radiated energy from the transmission source 301, signal improvement at the receiver 302 relative to that of a communication link without the Fresnel lens 100, or any combination. The predetermined angle 308 may be any angle whereby the Fresnel lens 100 is orthogonal to the transmission path. What is now needed are means to achieve optimal placement of the Fresnel lens 100 with regards to the predetermined angle. What is also needed are means to manipulate orientation of the Fresnel lens 100 in scenarios where the device does not remain in a fixed location, which would be the case with wireless portable electronic devices 1001 carried by a user in the field (e.g., hiker, camper, hunter, workers, etc.). Manipulating the orientation of the Fresnel lens will likely be directly physically and randomly by a user of a wireless device 1001 until the user is satisfied with the signal strength being obtained by the wireless device 1001 via signal enhancement provided the Fresnel lens 100.

Referring to FIG. 8, illustrated is a front-right perspective of a support structure in the form of a tent 800 for a Fresnel lens 100, according to an embodiment. Note that Fresnel lens 100 is still depicted, without intending limitation, in the shape of a circle or ring in FIG. 8. At least one surface 801/802 (e.g., wall or surface) of the tent 800 can support a fully deployed Fresnel lens 100 in a mostly upright position to enhance wireless communications of wireless device 1001 located within or near the tent 800 when the Fresnel lens 100 is integrated in the at least one surface 801/802.

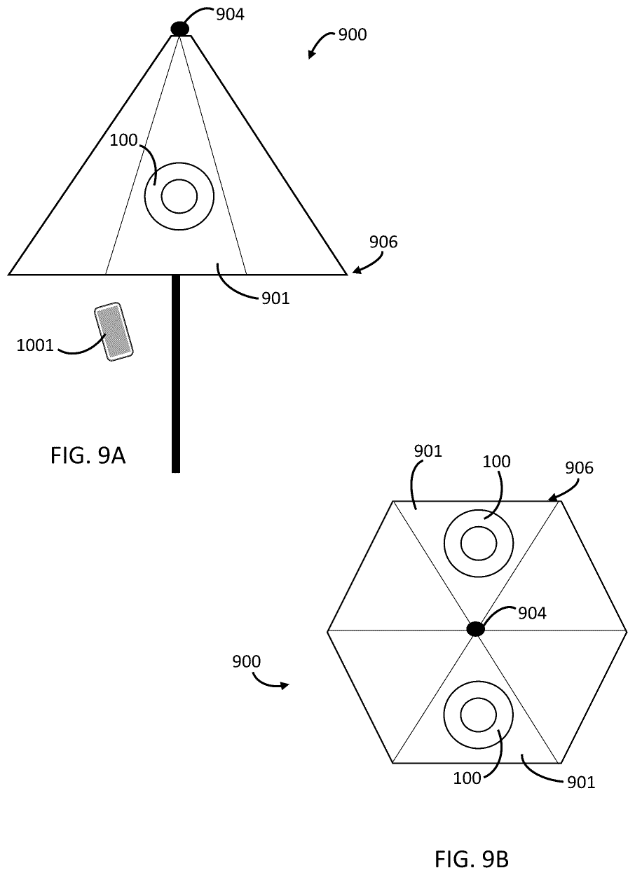

Referring to FIGS. 9A-B, depicted are side (FIG. 9A) and top (FIG. 9B) perspectives of an umbrella 900 serving as a support structure for a Fresnel lens 100, in accordance with another embodiment. Fresnel lens 100 is depicted, without intending limitation, in the shape of a circle or ring in FIGS. 9A-B disposed on the material surface 901 of the umbrella 900 between a center post 904 and the edge 906 of the material surface 903. A location between the center post 904 and edge 906 minimizes unwanted interference with the Fresnel lens that can be presented by the center post 904 if the Fresnel lens 100 ring were instead disposed around the center post 904 at the top of the umbrella 900. The material surface 901 of the umbrella 900 can support a fully deployed Fresnel lens 100 in a manner that can enhance wireless communications of wireless device 1001 located beneath or near the umbrella 900 when the Fresnel lens 100 is integrated into or onto the material surface 901 of the umbrella 900. The Fresnal lens can also be integrated into/onto the topside or bottomside of the material surface 901. On the bottomside, the Fresnel lens would not interfere with decorative aspects on the topside (outward surface) of material surface 901 that may be observed when standing away from the umbrella 900.

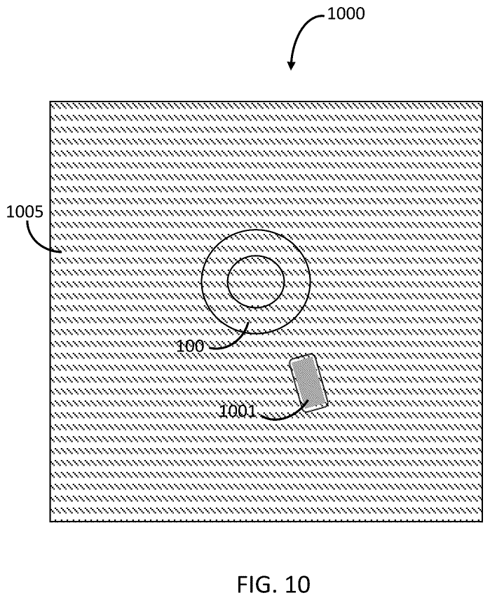

Referring to FIG. 10, depicted is a front perspective view of a screen 1000 serving as a support structure for a Fresnel lens 100, in accordance with yet another embodiment. Once again, Fresnel lens 100 is depicted, without intending limitation, in the shape of a circle or ring in FIG. 10. The surface 1001 of the screen 1000 can support a fully deployed Fresnel lens 100 in a manner that can enhance wireless communications of wireless device 1001 located near the screen 1000 when the Fresnel lens 100 is integrated on the material surface 901 of the screen 900. The screen can be provided for decorative, privacy or shading purposes and have the Fresnel lens 100 integrated into its décor while serving its enhanced communication purpose. It can be appreciated that the screen 1000 can also be provided in the form of a curtain that serves as a covering over a window or entry way.

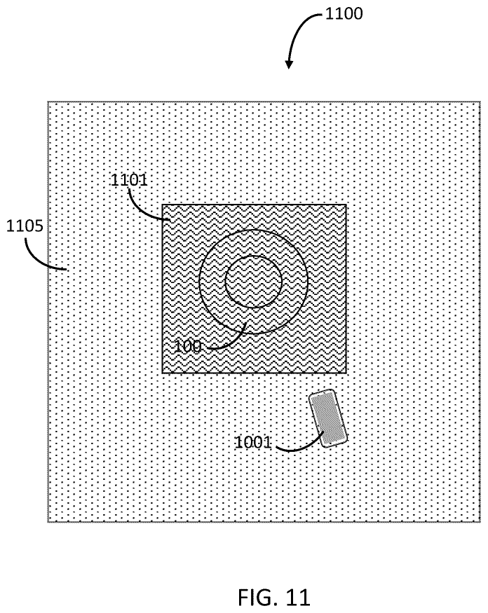

Referring to FIG. 11, depicted is a front perspective view of a window 1100 onto which a plastic layer material 1101 can serve as a support structure for a Fresnel lens 100, in accordance with yet another embodiment. Once again, Fresnel lens 100 is depicted, without intending limitation, in the shape of a circle or ring in FIG. 11. The plastic layer material 1101 can adhere to the surface 1105 of the widow 1100 and can support Fresnel lens 100 in a manner that can enhance wireless communications of wireless device 1001 located near the screen 1100 when the Fresnel lens 100 is integrated on the plastic layer material 1101 and adhered to the surface 1105 of the window 1100. The plastic layer material 1101 can be clear or tinted as is the case with window tinting film. The plastic layer material 1101 can also be provided for decorative, privacy or shading purposes and have the Fresnel lens 100 integrated into or onto its surface while serving its enhanced communication purpose. The plastic layer material 1101 can also be provided in the form of clear sheet that can adhere to just a portion of a window.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art. As used herein in the claim(s), when used in conjunction with the word “comprising”, the words “a” or “an” mean one or more.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. Means to improve wireless communications, comprising a Fresnel lens integrated onto the at least one surface of a nonconductive material serving an alternative function, wherein the Fresnel lens is configured to improve wireless communications by communication equipment located near the Fresnel lens by increasing signal to noise ratio (SNR) in wireless communication links.

2. The means to improve wireless communications 1, wherein the material further comprises surface fabric of a tent.

3. The means to improve wireless communications 2, wherein the tent includes at least one of a wall surface or a ceiling surface adapted to support the Fresnel lens.

4. The means to improve wireless communications 1, wherein the material further comprises a fabric cover of an umbrella.

5. The means to improve wireless communications 2, wherein the umbrella includes at least one panel surface adapted to support the Fresnel lens.

6. The means to improve wireless communications 1, wherein the material further comprises fabric of a decorative screen.

7. The means to improve wireless communications 2, wherein the screen includes a surface adapted to support the Fresnel lens.

8. The means to improve wireless communications 1, wherein the material further comprises fabric of a curtain adapted to cover a window or entry.

9. The means to improve wireless communications 1, wherein the material further comprises a plastic layer adapted to adhere to a window surface.
